(19) United States
(12) Patent Application Publication
(10) Pub. No.: US 2020/0130406 A1
(43) Pub. Date: Apr. 30, 2020

(54) PANEL COMPRISING AN END-GRAIN WOOD PATTERN, METHOD FOR PRODUCING A PATTERN FOR SUCH A PANEL, PANEL TRADING UNIT COMPRISING AT LEAST ONE PANEL OF THIS KIND, EMBOSSING ELEMENT FOR SUCH A PANEL AND DECORATIVE PAPER FOR SUCH A PANEL

(71) Applicant: KAINDL FLOORING GmbH, Wals (AT)

(72) Inventor: Gerhard DUERNBERGER, Strasswalchen (AT)

(73) Assignee: KAINDL FLOORING GmbH, Wals (AT)

(21) Appl. No.: 15/772,670

(22) PCT Filed: Aug. 24, 2016
(86) PCT No.: PCT/EP2016/069951

§ 371 Date: May 1, 2018

(30) Foreign Application Priority Data
Nov. 2, 2015 (DE) 10 2015 221 424.9

(51) Int. Cl. B44F 9/02; B44C 5/04

(52) U.S. Cl. CPC B44F 9/02; B44C 5/04

(57) ABSTRACT

The invention relates to a panel comprising a pattern which comprises at least two decorative portions, of which at least one is an end-grain wood surface. According to the invention, all of the decorative portions display a wood pattern. Furthermore, two decorative portions that are adjoining each other along a joint line are graphically processed adjacently to the joint line so as to result in an appearance that the human eye perceives to be natural and continuous.

The invention relates to a rectangular panel, in particular a panel intended for covering a substrate, comprising a base element which comprises a pattern on the visible surface thereof, the pattern comprising at least two decorative portions, of which at least one represents an end-grain wood surface.

The use of end-grain wood is for example known from cutting boards and flooring. In these cases, end-grain wood pieces, the end-grain wood surfaces of which usually have dimensions which do not exceed 10 cm×10 cm, adjoin one another substantially without any gaps, which gives the end-grain wood surfaces the known uneven appearance.

Patterns in which images of end-grain wood surfaces are used are also already known. One of the known patterns comprises individual pieces of end-grain wood embedded in chalky sandstone. Another known pattern comprises pieces of end-grain wood stacked on each other, the gaps between the end-grain wood pieces being kept dark in order to represent hollow spaces. These two patterns therefore do not have a wood pattern which covers the entire surface.

By way of contrast, the object of the invention is to provide panels, the pattern of which has the appearance of a continuous wood surface despite the presence of the at least two decorative portions, at least one of which represents an end-grain wood.

This object is achieved according to the invention by a panel of the type mentioned at the outset, in which all of the decorative portions display a wood pattern, and in which two decorative portions adjoining each other along a joint line are graphically processed adjacently to the joint line according to at least one of the following steps:
a) extending at least some of the decorative elements that form the wood pattern of one decorative portion into the other decorative portion,
b) merging decorative elements that form the wood pattern of the two decorative portions into one another in a substantially tangential manner,
c) incorporating additional decorative elements,
d) processing at least one decorative sub-portion of at least one of the decorative portions by blurring and/or highlighting,
e) assimilating the colors of the two wood patterns to one another.

Despite the fact that, in nature, there may be at best occasionally trees having a diameter that would enable an end-grain wood pattern having dimensions corresponding to those of a commercially available panel to be directly taken from said tree after it has been felled, for example by taking photographs, the present invention makes it possible to provide a wood pattern covering the entire surface of the panel that gives the appearance of a joint-less end-grain wood surface.

In connection with the present invention, decorative elements that form the wood pattern may be growth rings and/or medullary rays and/or cracks and/or calluses and/or bark inclusion and/or knots and/or saw marks, for example.

The joint line, along which the decorative portions are joining each other, does not necessarily have to extend in a straight line and nor does it have to extend substantially in parallel with the short sides of the rectangular panel. Instead, it is also conceivable for the joint line to follow the course of at least one of the decorative elements that form the wood pattern, at least in portions. In this case, it is possible to make full use of textures of these decorative elements that occur as a result of the position and orientation of the depicted cutting plane of the wood, for example crowns (flower grains) of growth rings which occur in an end-grain wood portion for example at the point where branches begin to extend laterally out of the tree trunk.

When some of the decorative elements that form the wood pattern of one decorative portion extend into the adjacent decorative portion, this can occur for example such that the decorative elements that form the wood pattern of the other decorative portion can nevertheless remain preserved. In other words, decorative sub-portions of the two adjoining decorative portions overlap one another such that substantially all of the decorative elements that form the wood pattern of the two decorative sub-portions can still be seen.

As a result, also decorative structures can be produced that perhaps do not occur as such in nature but that can still be recognized by the visual center of the brain as wood textures owing to their similarity to an end-grain wood structure produced as a result of the interaction between the growth rings that tend to extend around the pith in the circumferential direction and the medullary rays which tend to extend radially with respect to the pith.

In order to create a distinction between terms, it should be noted that the situation in which only the decorative elements of one decorative portion can be seen if decorative portions overlap one another, can, in connection with the present invention, also be described by a non-linear course of the joint line, since the decorative portion of which the decorative elements can no longer be seen also can be considered to not form a part of the decorative portion thereof.

When the decorative elements that form the wood pattern of the two decorative portions, for example growth rings and/or medullary rays, are merged into one another in a substantially tangential manner, it is also possible for a decorative element of one decorative portion, for example a growth ring, to end adjacently to the joint line, whereas decorative elements adjoining this decorative element are merged into associated decorative elements of the other decorative portion, respectively, in a substantially tangential manner.

During processing by means of blurring and/or highlighting, it is conceivable for the degree of blurring and/or highlighting to vary over the surface of the decorative sub-portion. It is also possible for just some of the decorative elements of the decorative sub-portion, for example the growth rings and/or the medullary rays, to be processed by means of blurring and/or highlighting, whilst other decorative elements, for example cracks, are unprocessed.

In connection with the present invention, “highlighting” can be understood to mean highlighting by increasing the contrast compared with the surrounding pattern, in particular by using a darker shade of the same color type, for example by using a darker shade of brown, and/or highlighting by widening a line shape, for example a growth ring and/or a medullary ray.

In this context, it should also be pointed out how important it is for the colours of the adjacent decorative portions to be assimilated and for the colour ranges used to depict the two adjacent decorative portions to be assimilated in order for said portions to be recognized by the eye of the viewer as being part of the same pattern.

Another option for graphically processing the decorative portions which are adjoining each other along a joint line is to insert additional decorative elements, for example images of at least one knot and/or at least one callus and/or at least one bark inclusion on and/or in the vicinity of the joint line. Such additional decorative elements are advantageous in that the eye of the viewer is used to the fact that there may be discontinuities in the wood pattern at these additional decorative elements. Wood patterns comprising such additional decorative elements are often seen by consumers as being rustic and highly appealing.

According to a further embodiment of the invention, it is proposed that the decorative portions adjoining the short sides of the panel are designed such that, if two panels that are designed in an identical manner and are provided with an identical pattern are joined to one another by the short sides thereof, the patterns of the two panels transition into one another. By virtue of this embodiment, it is possible for the panel pattern to be printed, for example using a printing cylinder, on a decorative layer reel, for example a decorative paper reel, from which reel the individual decorative layers can then be separated without having to be mindful of a repetition in the pattern. In order for the patterns to transition into one another, the patterns of the panels can also be graphically processed on the short sides thereof according to at least one of the aforementioned steps a) to e).

Additionally or alternatively, it can be provided that the patterns of at least two panels that are designed in an identical manner and are provided with an identical pattern are designed such that, if the panels adjoin one another by the long sides thereof such that the short sides thereof are aligned with one another, said panels transition into one another. In order for the patterns to laterally transition into one another, the patterns of the panels may also be graphically processed on the long sides thereof according to at least one of aforementioned steps a) to e). As a result, decorative layers can be provided that can be freely cut laterally.

According to the above, it is conceivable for a decorative paper to be provided on the surface of the panel, which decorative paper is printed with the wood pattern. In order to at least counteract, or even completely prevent, the “cupping” of the panel when using a decorative paper, it is advantageous for a balance paper to be arranged on the surface of the panel which is opposite to the visible surface thereof.

As an alternative to using a decorative paper, it is however also conceivable for a priming coat to be provided on the surface of the panel, which priming coat is printed with the wood pattern.

In order to prevent the wood pattern from being abraded or similarly damaged, it is proposed that a preferably transparent protective coating be provided on the surface of the decorative layer printed with the wood pattern or of the priming coat printed with the wood pattern. The protective coating may for example be made of a synthetic resin.

In order to achieve a natural appearance, it is also proposed that the panel be provided with a texture which is substantially synchronous with the grain of the wood pattern. The texture may for example be introduced into the protective coating by means of an embossing tool, preferably an embossing punch or an embossing roller. In so doing, at least some of the impressions in the texture can have a depth profile.

As is known per se, the base element of the panel can be made of MDF (medium density fiberboard) and/or HDF (high density fiberboard) and/or OSB (oriented strand board) and/or a chipboard and/or plywood and/or a strip board and/or a gypsum fiber board and/or a plastics board, for example a PVC board, in particular LVTs (luxury vinyl tiles).

The panel according to the invention can be used for example as a flooring panel or as a wall lining panel or as a ceiling lining panel or as a furniture board or as a work surface. In this case, the floor or the wall or the ceiling or the body of the furniture or the supporting structure of the work surface, respectively, form the substrate to be covered by the panel.

Furthermore, the length of the panel can be between 500 mm and 2800 mm and/or the width of the panel can be between 80 mm and 450 mm and/or the thickness of the panel can be between 1 mm and 25 mm.

Finally, in order to permit a connection to other panels, the panel can be designed to have connection elements of the tongue-and-groove type on the two long side edges and/or the two short side edges thereof.

According to another aspect, the invention relates to a method for producing a pattern comprising at least two decorative portions, of which at least one is an end-grain wood surface, in particular for a rectangular panel which may be intended for covering a substrate according to the above discussion. In this case, the method according to the invention is characterized in that all of the decorative portions display a wood pattern, and in that two decorative portions that are adjoining each other along a joint line are graphically processed adjacently to the joint line according to at least one of the following steps:
a) extending at least some of the decorative elements that form the wood pattern of one decorative portion into the other decorative portion,
b) merging decorative elements that form the wood pattern of the two decorative portions into one another in a substantially tangential manner,
c) incorporating additional decorative elements,
d) processing at least one decorative sub-portion of at least one of the decorative portions by blurring and/or highlighting,
e) assimilating the colors of the two wood patterns to one another.

With respect to the advantages that can be achieved by said method, reference is made to the above discussion of the panel according to the invention.

According to a third aspect, the invention relates to a panel trading unit comprising a plurality of panels comprising a wood pattern over the entire surface thereof, wherein at least some of the panels in the panel trading unit are panels according to the invention comprising end-grain wood patterns.

According to a further embodiment of this third aspect of the invention, it is proposed that the wood pattern of at least one of the panels in the panel trading unit, which does not comprise an end-grain wood pattern, display the image of a knot and/or a callus and/or a bark inclusion. Owing to the fact that knots, calluses and bark inclusions have an uneven appearance like that of end-grain wood, the panels comprising end-grain wood patterns and the panels comprising the afore-mentioned patterns make up a surface covering having a rustic appearance.

According to a fourth aspect, the invention relates to a decorative paper for producing a panel according to the invention.

In the following, the invention will be described in more detail with reference to the accompanying drawings of embodiments, in which drawings:

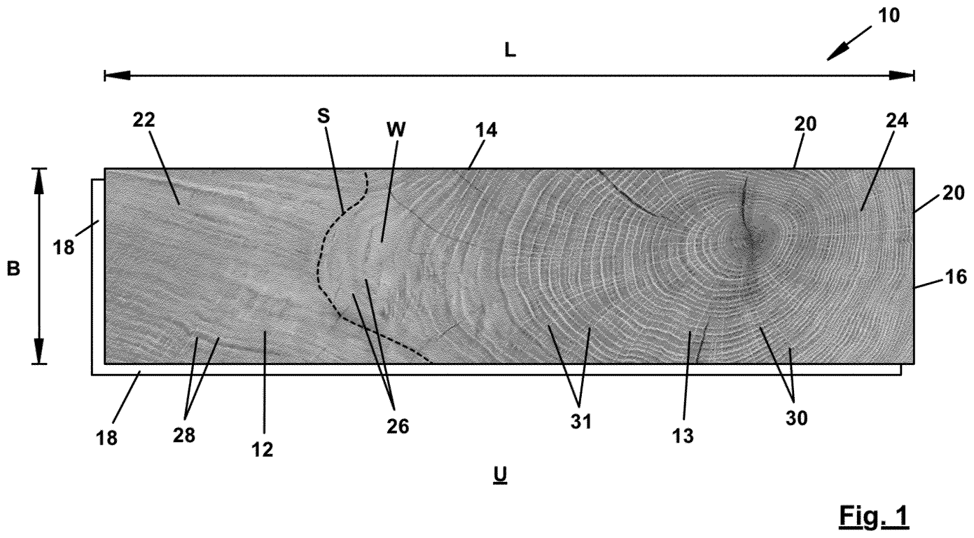

FIG. 1 shows a plan view of a panel according to the invention comprising a first pattern produced according to the invention;

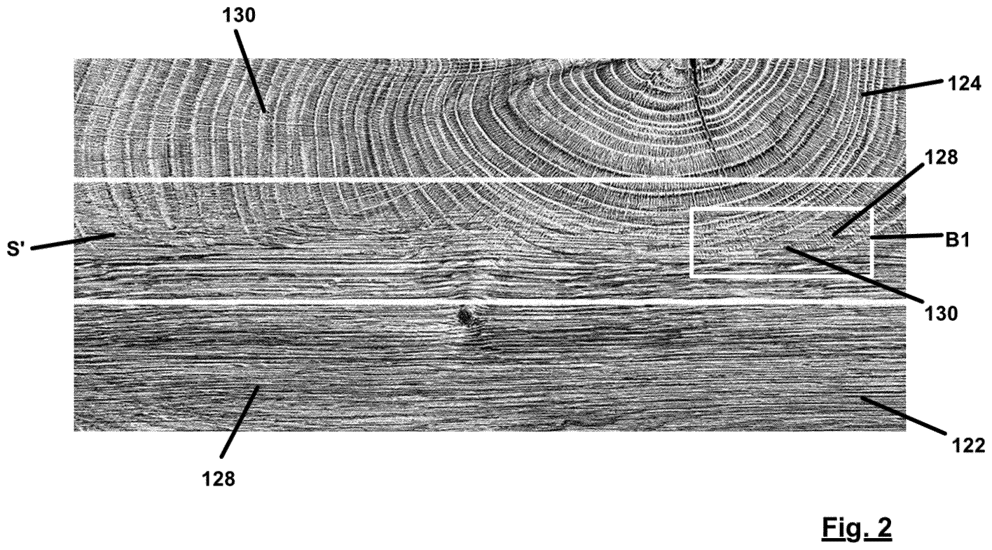

FIG. 2 shows a second pattern produced according to the invention;

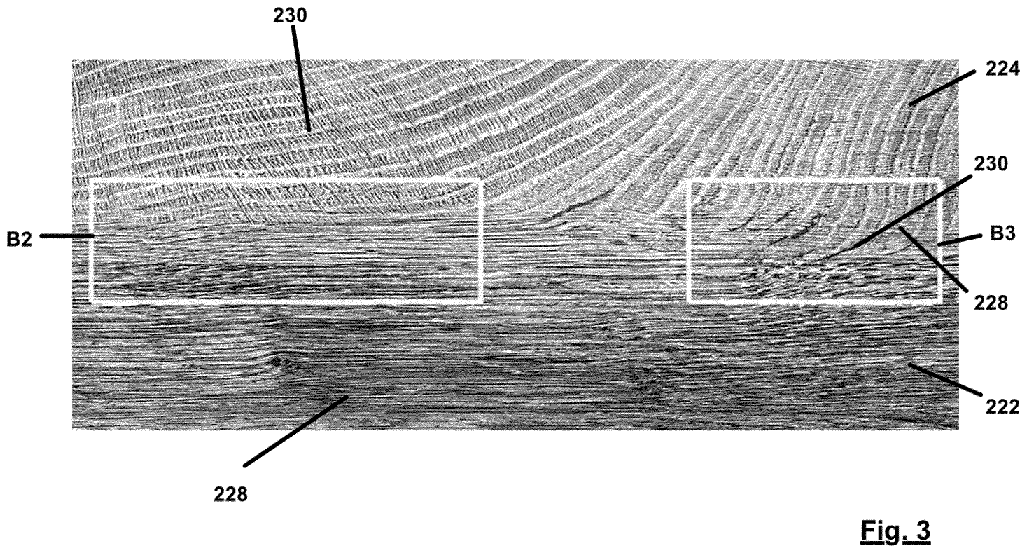

FIG. 3 shows a third pattern produced according to the invention;

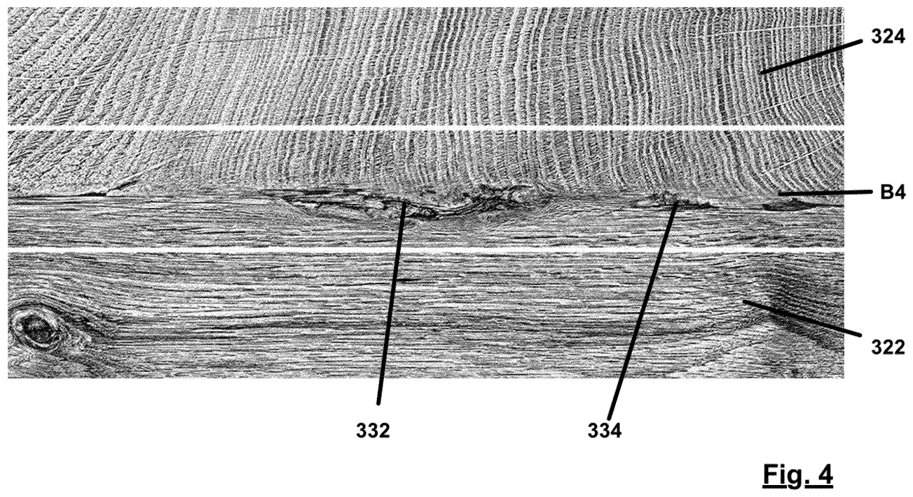

FIG. 4 shows a fourth pattern produced according to the invention;

FIG. 5 shows a schematic cross section of a panel according to the invention;

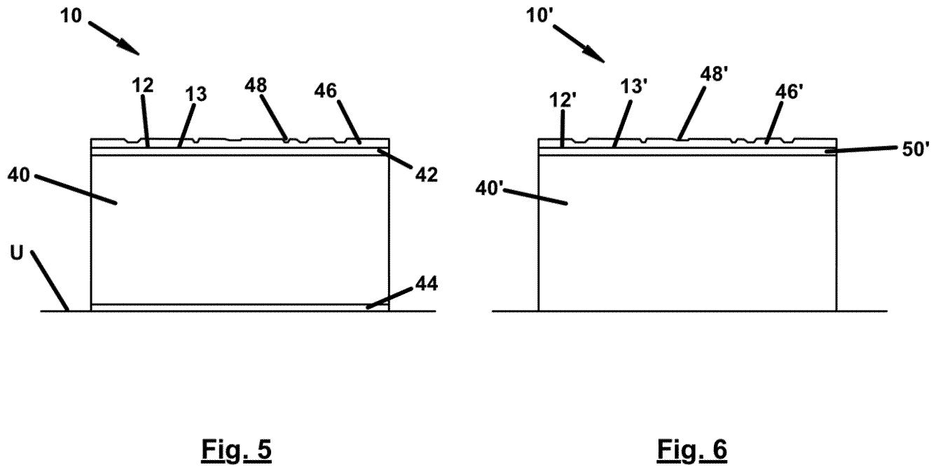

FIG. 6 shows a schematic cross section of an alternative panel according to the invention; and

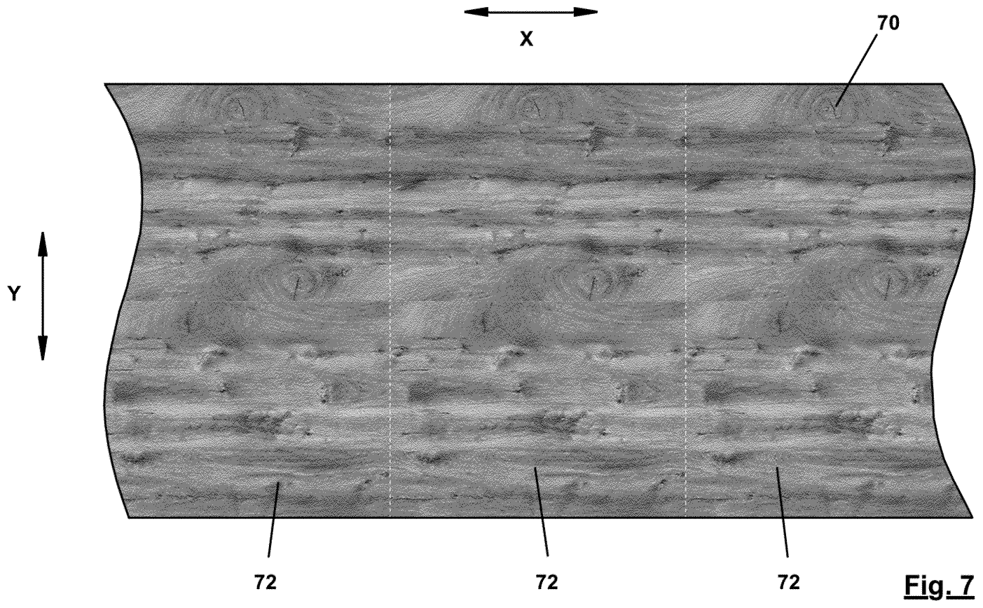

FIG. 7 shows a decorative paper according to the invention comprising a fifth pattern produced according to the invention.

In FIG. 1, a flooring panel according to the invention is designated by reference numeral 10. The panel 10 may be used to cover a substrate U (see FIG. 5), for example the floor and/or the ceiling and/or a wall of a room or the body of furniture or the supporting structure of a work surface.

In FIG. 1, the panel 10 is shown in plan view and comprises a wood pattern 13 on the upper surface 12 thereof. The upper surface 12 of the panel 10 is rectangular and has a long side 14 of length L and a short side 16 of length B. A tongue 18 of a tongue-and-groove joint is shown on one long side 14 and one short side 16 of the panel 10. The respectively opposing long and short sides 14 and 16 are accordingly designed comprising grooves 20 (not visible in FIG. 1) of the tongue-and-groove joint. As a result, it is possible to lay the panels in a known manner.

The wood pattern 13 on the upper surface 12 of the panel 10 comprises a first decorative portion 22 and a second decorative portion 24 which are adjoining each other along a joint line S.

The first decorative portion 22 depicts a grain of the longitude-grain type, i.e. a piece of wood which is cut along the height of the tree and thus substantially in the direction of the wood fibers. The wood fibers 28 are clearly visible in the first decorative portion 22 and, in the depiction shown, extend substantially in parallel with one another diagonally from top left to bottom right.

Conversely, the second decorative portion 24 depicts a grain of the end-grain type, i.e. a piece of wood that is cut perpendicularly to the height of the tree and thus also perpendicularly to the course of the fibers. The typical features of end-grain wood can be seen in the second decorative portion 24, for example the substantially concentric growth rings 30 and the medullary rays 31 which extend outwards from the inside.

It should be noted that the joint line S does not extend in a straight line and in particular not substantially in parallel with the short sides 18, but instead assumes a course that is adapted to the pattern of one of the decorative portions 22, 24, which, in the present case, is the pattern of the decorative portion 24. In particular, said line follows a curve which corresponds to the outermost growth ring 30 of the second decorative portion 24. So as to be able to achieve a visually appealing transition between the first decorative portion 22 and the second decorative portion 24 at the joint line S, a region W of the second decorative portion 24 in the vicinity of the joint line S has been treated using blurring in order to reduce the contrast of the fibrous structure of the first decorative portion 22 and of the growth rings and medullary rays of the second decorative portion 24 and in order to produce a low-contrast region U around the joint line S. Moreover, fibrous structures 26 have been incorporated into the region W, which structures transition into the pattern of the decorative portion 22 at the joint line S in a substantially step-less manner.

Even though the pattern of the panel 10 from FIG. 1 does not have a natural pattern since, in nature, end-grain wood regions and longitude-grain wood regions do not usually occur one next to the other or transition into one another, the blurred region W and the incorporated fibrous structures 26 nonetheless result in a pattern which the human eye does not recognize as being man-made, but which instead appears natural to the human eye.

FIG. 2 shows a second pattern produced according to the invention which can be provided on a panel according to the invention in the same way as the pattern shown in FIG. 1. Likewise, the pattern shown in FIG. 2 comprises a first decorative portion 122 and a second decorative portion 124, the first decorative portion 122 once again representing a grain of the longitude-grain type, and the second decorative portion 124 once again representing a grain of the end-grain type. Unlike in the pattern shown in FIG. 1, the joint line in the pattern of FIG. 2 does not follow a clear course. Instead, said line is located inside the transition region S′ which is represented by two white lines in FIG. 2, in which transition region the patterns of the two decorative portions 122 and 124 transition into one another. This visual impression of transitioning into one another is achieved by individual elements of each of the two decorative portions 122 and 124 extending into the pattern of the other decorative portion, respectively.

In this regard reference is made by way of example to the region B1 marked in FIG. 2, in which both fibrous structures 128 of the first decorative portion 122 and the growth rings 130 of the second decorative portion 124 can be seen. Since, in this region B1, the growth rings 130 of the second decorative portion 124 tangentially approach the course of the fibrous structures 128 of the first decorative portion 122, a transition which appears natural to the human eye is produced as a result of the growth rings 130 extending into the first decorative portion 122.

In a similar manner to FIG. 2, FIG. 3 shows a third pattern produced according to the invention which can be provided on a panel according to the invention, likewise in the same way as the pattern shown in FIG. 1, and which once again comprises a first decorative portion 222 and a second decorative portion 224. In this figure, two regions B2 and B3 are indicated by means of respective white rectangular borders, in which regions further techniques have been used to produce a transition between the first decorative portion 222 and the second decorative portion 224 that is appealing to the human eye.

In region B2, the growth rings 230 of the second decorative portion 224 extend so as to tangentially approach the fibrous structures 228 of the first decorative portion 222 and therefore transition into said first decorative portion in a substantially kink-free manner. As discussed with reference to the region B1 in FIG. 2, such a tangential transition can automatically ensure that the transition between the two decorative portions 222 and 224 appears natural. However, in contrast to region B1 from FIG. 2, in this case, in region B2, elements of a decorative portion 222 or 224 do not extend into the respective other decorative portion; instead, only a color gradient is incorporated which results in a fluent color transition between the two decorative portions 222 and 224 and produces, together with the tangential and kink-free transition of the growth rings 230 of the second decorative portion 224 into the fibrous structures 228 of the first decorative portion 222, an appearance that the viewer perceives to be natural.

In region B3, the contrast of individual fibrous structures 228 of the first decorative portion 222 and individual growth rings 230 of the second decorative portion 230 is increased compared with the pattern surrounding them, specifically by coloring using a darker shade and by widening, at least in portions, the lines depicting said fibrous structures and growth rings. In this case, the darker shade is selected such that the coloring of the lines is similar to the pattern of one of the two decorative portions 222 and 224 (in this case the decorative portion 222). In this manner, the transition between the two decorative portions 222 and 224 appears to be continuous and therefore natural to the human eye.

Finally, another option for joining together two decorative portions 322 and 324 in a visually pleasing manner is shown in FIG. 4. In this case, additional decorative elements such as calluses 332 and bark inclusions 334 have been incorporated along the joint line in the highlighted region B4, which decorative elements likewise extend substantially along the joint line between the two decorative portions 322 and 324.

The human eye is used to the fact that there may be discontinuity in the markings of the wood surrounding calluses 332 or bark inclusions 334 in wood and in particular that the transition of fibers or growth rings in calluses or bark inclusions is not usually continuous. Therefore, the additional decorative elements 332, 334 in the region B4 in FIG. 4 look like a natural transition between the two decorative portions 322 and 324. In particular, the human eye does not permanently assign these elements to one of the two decorative elements, since both the longitude grain of the first decorative portion 322 and the end grain of the second decorative portion 324 could comprise the corresponding calluses 332 or bark inclusions 334.

FIG. 5 is a schematic cross section of a first panel 10 according to the invention, for example the panel from FIG. 1. Therefore, where possible, the same reference numerals have been used in this figure as in FIG. 1. The panel comprises a base board 40. A layer 42 and 44 is applied on the upper face and lower face, respectively, of the base board 40, the layer 42 which is remote from the substrate U being printed with a pattern 13. The layer 42 is thus referred to as the “decorative layer”, while the layer 44 opposite the decorative layer 42 is referred to as the “counteracting layer” because the function thereof is to compensate stresses that may occur in the panel 10 as a result of the decorative layer 42 shrinking or expanding, and said counteracting layer 44 thus ensures that the panel 10 does not warp.

Finally, a transparent protective coating 46 is applied to the decorative layer 42, which protective coating can be made of a synthetic resin or the like. A texture 48 can also be embossed in the protective coating 46 on the upper surface 12 of the panel 10, which texture can preferably be designed to be substantially synchronous with the pattern 13 printed on the decorative layer 42. This texture 48 increases the natural wood-like appearance of the panel 10 as a result of the surface feel and roughness thereof.

FIG. 6 is a schematic cross section of an alternative panel 10′ according to the invention. In this panel, there is no need to apply a special decorative layer to the base material 40′; instead, the base material is merely provided with a priming coat 50′ which can be directly printed with the pattern 13′. As with the panel 10 shown in FIG. 5, the panel 10′ from FIG. 6 is also provided with a protective coating 46′ and a texture 48′ embossed therein.

The base board 40 and 40′ can be produced for example from MDF (medium density fiberboard), HDF (high density fiberboard), OSB (oriented strand board), a chipboard, PVC (polyvinylchloride), in particular LVT (luxury vinyl tiles) or any another suitable material.

When using MDF, HDF, OSB or chipboard as the material of the base board 40, the layers 42, 44 can preferably be made of paper, and when using PVC, said layers can preferably be made of plastics material. Furthermore, said layers can be connected to the base board, for example using synthetic resin.

Finally, it should be noted that, when producing the panels 10 according to the invention shown in FIG. 5, the panels are not usually covered with a decorative layer 42 in a panel-by-panel manner. Instead, panels, referred to as “large plates”, the surface area of which at least corresponds to the surface area of a plurality of panels 10, are covered with a sheet of decorative layers which is of a corresponding size. The large plate provided with the pattern in this manner is then sawed up into individual unfinished panels. These unfinished panels become panels 10 according to the invention by providing the tongue-and-groove connection elements 18, 20 by milling the long and short sides 14, 16 of the unfinished panels.

The decorative layer sheets required for covering the large plates are usually printed by means of printing rollers, the circumference of which corresponds to a multiple of the length of one panel 10. Using these printing rollers, virtually endless lengths of decorative layers can be printed which can then be split into the decorative layers sheets when required.

In this context, FIG. 7 shows a detail of such a length 70 of decorative layers, the length of which approximately corresponds to the length of the decorative layer sheets 72 (indicated by dashed lines).

It can be seen from FIG. 7 that the pattern of the decorative layer sheets 72 is designed such that it endlessly repeats in the longitudinal direction X. In other words, the pattern of two adjacent decorative layer sheets 72 precisely transition into one another. When splitting the length 70 of decorative layers, there is therefore no need to consider where exactly the length 70 of decorative layers should be split.

FIG. 7 also shows that the pattern of the lengths 72 of decorative layers has three portions which each correspond to one panel width respectively in the transverse direction Y and comprise an end-grain wood pattern according to the invention, whereas the other portions which each correspond to one panel width respectively comprise a longitude-grain wood pattern. In this case, the lateral transitions from portion to portion are designed using the image processing strategies described with reference to FIG. 1 to 4 such that the patterns of adjacent panels transition into one another in a continuous manner. As a result, it is possible to prevent adverse effects on the appearance of the panels 10 arising after the large plate has been split into individual panels.

In particular, specifically owing to the decorative paper sheet 72 being impregnated with synthetic resin, using decorative paper sheets can result in “paper growth”, i.e. expansion of the decorative paper sheet 72, which expansion can amount to several millimeters over the extension of the decorative paper sheet 72. Since the large plates are always split into individual panels 10 along the same sawing lines, the pattern can shift onto the individual panels 10. The patterns of the portions of the decorative paper sheet 72 that correspond to the patterns of the individual panels 10 now transition into one another in a continuous manner, or to use terms known in the field, the pattern of the decorative paper sheet 72 can be laterally cut in a free manner, and it is therefore possible to avoid these adverse effects on the appearance of the panels 10.

It should also be noted that the panels 10 produced from a large plate 74 together form a panel trading unit that, when wrapped in packaging, can be used as a sales unit on the market. This panel trading unit can comprise a plurality of panels comprising end-grain wood patterns, the remainder of the panels being provided with a longitude-grain wood pattern. In this case, the pattern of the panels provided with a longitude-grain wood pattern can comprise the image of a knot and/or a callus and/or a bark inclusion in order to produce an uneven appearance similar to that of the panels provided with an end-grain pattern (see FIG. 7).

Finally, it should also be noted that the patterns cannot only be applied to the decorative layer 42 or the priming coat 50′ using plate cylinders, but also using digital printing process, in particular inkjet printing.

1. Rectangular panel, in particular intended for covering a substrate, comprising a base element which comprises a pattern on the visible surface thereof, the pattern comprising at least two decorative portions, of which at least one is an end-grain wood surface, characterized in that all of the decorative portions display a wood pattern, and in that two decorative portions that are adjoining each other along a joint line are graphically processed adjacently to the joint line according to at least one of the following steps:
a) extending at least some of the decorative elements that form the wood pattern of one decorative portion into the other decorative portion,
b) merging decorative elements that form the wood pattern of the two decorative portions into one another in a substantially tangential manner,
c) incorporating additional decorative elements,
d) processing at least one decorative sub-portion of at least one of the decorative portions (22, 21) by blurring and/or highlighting,
e) assimilating the colors of the two wood patterns to one another.

2. Panel according to claim 1,
characterized in that the joint line follows the course of at least one of the decorative elements that form the wood pattern, at least in portions.

3. Panel according to claim 1,
characterized in that the pattern is designed such that, even after step a) has been carried out, the decorative elements that form the wood pattern of the other decorative portion are preserved.

4. Panel according to claim 1,
characterized in that the degree of blurring and/or highlighting varies over the surface of the decorative sub-portion.

5. Panel according to claim 4,
characterized in that only some of the decorative elements of the decorative sub-portion are processed by means of blurring and/or highlighting, whilst other decorative elements are unprocessed.

6. Panel according to claim 1,
characterized in that the decorative portions that are adjacent to the shod sides of the panel are designed such that if two panels that are designed in an identical manner and are provided with an identical pattern are joined to one another by the shod sides thereof, the patterns of the two panels transition into one another.

7. Panel according to claim 1,
characterized in that a decorative layer, for example a decorative paper, is provided on the panel, which decorative layer is printed with the wood pattern.

8. Panel according to claim 1,
characterized in that a priming coat is provided on the panel, which priming coat is printed with the wood pattern.

9. Panel according to claim 7,
characterized in that a, preferably transparent, protective coating is provided on the face of the decorative layer printed with the wood pattern or of the priming coat printed with the wood pattern.

10. Panel according to claim 1,
characterized in that the panel is provided with a texture which is substantially synchronous with the grain of the wood pattern.

11. Method for producing a pattern comprising at least two decorative portions, of which at least one is an end-grain wood surface, in particular for a rectangular panel according to claim 1, characterized in that all of the decorative portions display a wood pattern, and in that two decorative portions that are adjoining each other along a joint line are graphically processed adjacently to the joint line according to at least one of the following steps:
a) extending at least some of the decorative elements that form the wood pattern of one decorative portion into the other decorative portion,
b) merging the decorative elements that form the wood pattern of the two decorative portions into one another in a substantially tangential manner,
c) incorporating additional decorative elements,
d) processing at least one decorative sub-portion of at least one of the decorative portions by blurring and/or highlighting,
e) assimilating the colors of the two wood patterns to one another.

12. Panel trading unit comprising a plurality of panels comprising a wood pattern over the entire surface thereof, wherein at least some of the panels in the panel trading unit are designed according to claim 1.

13. Panel trading unit according to claim 12,
characterized in that the wood pattern of at least one of the panels in the panel trading unit, which does not comprise an end-grain wood pattern, displays the image of a knot and/or a callus and/or a bark inclusion.

14. Decorative paper for producing a panel according to claim 1.
